(19) United States
(12) Patent Application Publication
(10) Pub. No.: US 2023/0368663 A1
(43) Pub. Date: Nov. 16, 2023

(54) SYSTEM, METHOD AND APPLICATION FOR LEAD VEHICLE TO TRAILING VEHICLE DISTANCE ESTIMATION

(71) Applicant: Ford Global Technologies, LLC, Dearborn, MI (US)

(72) Inventors: Matthew PUCHALSKI, Pittsburgh, PA (US); Nikolaus WITTENSTEIN, Pittsburgh, PA (US)

(21) Appl. No.: 17/743,083

(22) Filed: May 12, 2022

(51) Int. Cl. G08G 1/0967; B60W 60/00

(52) U.S. Cl. CPC G08G 1/096741; B60W 60/001; B60W 2554/4041; B60W 2554/802; B60W 2556/45

(57) ABSTRACT

An autonomous vehicle having a lead vehicle training system may include at least one processor coupled to the memory and programmed to receive sensor data indicative of a location of a vehicle trailing the autonomous vehicle, determine a distance between the vehicle trailing the autonomous vehicle and the autonomous vehicle, compare the distance with at least one predefined threshold distance, and issue an alert responsive to the comparison to provide instructions to the vehicle trailing the autonomous vehicle.

### TECHNICAL FIELD

One or more embodiments relate to systems, methods and applications for lead vehicle to trailing vehicle distance estimation.

### BACKGROUND

An autonomous vehicle may include a system to monitor its external environment to detect the presence of specific objects, e.g., traffic lights, street signs, and other vehicles. The system may include sensors or cameras for detecting the objects. The system may also use one or more strategies to determine the location of the objects based on data from the sensors or cameras. The system may also determine the three-dimensional (3D) location of the specific objects relative to the vehicle. The vehicle may control one or more other vehicle systems, e.g., braking and steering, based on these 3D locations.

### SUMMARY

An autonomous vehicle having a lead vehicle training system may include a memory, and at least one processor coupled to the memory and programmed to receive sensor data indicative of a location of a vehicle trailing the autonomous vehicle, compare a distance between the vehicle trailing the autonomous vehicle and the autonomous vehicle with at least one predefined threshold distance, and issue an alert responsive to the comparison to provide instructions to the vehicle trailing the autonomous vehicle.

A method may include receiving sensor data indicative of a location of a vehicle trailing an autonomous vehicle, comparing a distance between the vehicle trailing the autonomous vehicle and the autonomous vehicle with at least one predefined threshold distance, and issuing an alert responsive to the comparison to provide instructions to the vehicle trailing the autonomous vehicle.

A non-transitory computer-readable medium having instructions stored thereon that, when executed by at least one computing device, cause the at least one computing device to perform operations comprising receiving sensor data indicative of a location of a vehicle trailing an autonomous vehicle, comparing a distance between the vehicle trailing the autonomous vehicle and the autonomous vehicle with at least one predefined threshold distance, and issuing an alert responsive to the comparison to provide instructions to the vehicle trailing the autonomous vehicle.

### BRIEF DESCRIPTION OF THE DRAWINGS

The accompanying drawings are incorporated herein and form a part of the specification.

FIG. 1 illustrates an exemplary autonomous vehicle system, in accordance with aspects of the disclosure.

FIG. 2 illustrates an exemplary architecture for a vehicle, in accordance with aspects of the disclosure.

FIG. 3 is an example computer system useful for implementing various embodiments.

FIG. 4A illustrates an example schematic of an autonomous vehicle and a trailing vehicle at a first time.

FIG. 4B illustrates an example schematic of an autonomous vehicle and a trailing vehicle at a second time.

FIG. 4C illustrates an example schematic of an autonomous vehicle and a trailing vehicle at a third time.

FIG. 5A illustrates an example display presenting a visual alert;

FIG. 5B illustrates an example display presenting another visual alert; and

FIG. 6 is a flow chart illustrating a method for the vehicle system of FIG. 1

In the drawings, like reference numbers generally indicate identical or similar elements. Additionally, generally, the left-most digit(s) of a reference number identifies the drawing in which the reference number first appears.

### DETAILED DESCRIPTION

As required, detailed embodiments are disclosed herein; however, it is to be understood that the disclosed embodiments are merely exemplary and may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present disclosure.

Disclosed herein is a system for a self-driving car to communicate with another non-self-driving car to mitigate rear end damage to the self-driving car or to communicate with an occupant of the self-driving car. Traditionally, vehicles do not offer feedback to other vehicles, especially those vehicles driving behind an autonomous vehicle. To communicate with a trailing vehicle, the driver of the lead vehicle may possibly honk, motion with his or her hands, etc. Some lead vehicles may have bumper stickers, or other signage that may indicate how the lead vehicle may operate, e.g., student driver, delivery vehicle, text such as “this vehicle makes frequent stops,” etc. A rear-end collision of an autonomous lead vehicle by the trailing vehicle may be possible. In some instances, the occupant may be a test specialist responsible for taking over control of the self-driving car during development. By communicating with the test specialist, the system described herein enables the test specialist to be aware of the proximity of the trailing car and to prepare for taking over control of the self-driving car, if necessary.

In self-driving systems, it is often possible to leverage a vehicle’s existing sensing and computing capabilities to send estimated and predicted information to other vehicles to mitigate a read-end collision event. The lead vehicle may be capable of detecting, tracking, and predicting the distance between the lead vehicle and the trailing vehicle. In response to a threshold distance being exceeded, the lead vehicle may provide a warning to the trailing vehicle to possibly avoid collision.

In one example, the lead vehicle may communicate with the trailing vehicle via vehicle-to-vehicle (V2V) methods. In another example, the lead vehicle may have a display arranged on the lead vehicle but visible to the trailing vehicle, such as in the back window, on the lead vehicle’s bumper, etc. The display may be configured to convey information to the trailing vehicle, such as how close the trailing vehicle is to the lead vehicle, warnings, etc.

The term “vehicle” refers to any moving form of conveyance that is capable of carrying either one or more human occupants and/or cargo and is powered by any form of energy. The term “vehicle” includes, but is not limited to, cars, trucks, vans, trains, autonomous vehicles, aircraft, aerial drones and the like. An “autonomous vehicle” (or “AV”) is a vehicle having a processor, programming instructions and drivetrain components that are controllable by the processor without requiring a human operator. An autonomous vehicle may be fully autonomous in that it does not require a human operator for most or all driving conditions and functions, or it may be semi-autonomous in that a human operator may be required in certain conditions or for certain operations, or that a human operator may override the vehicle’s autonomous system and may take control of the vehicle.

Notably, the present disclosure is being described herein in the context of an autonomous vehicle. However, the present disclosure is not limited to autonomous vehicle applications. The present disclosure may be used in other applications such as robotic applications, radar system applications, metric applications, and/or system performance applications.

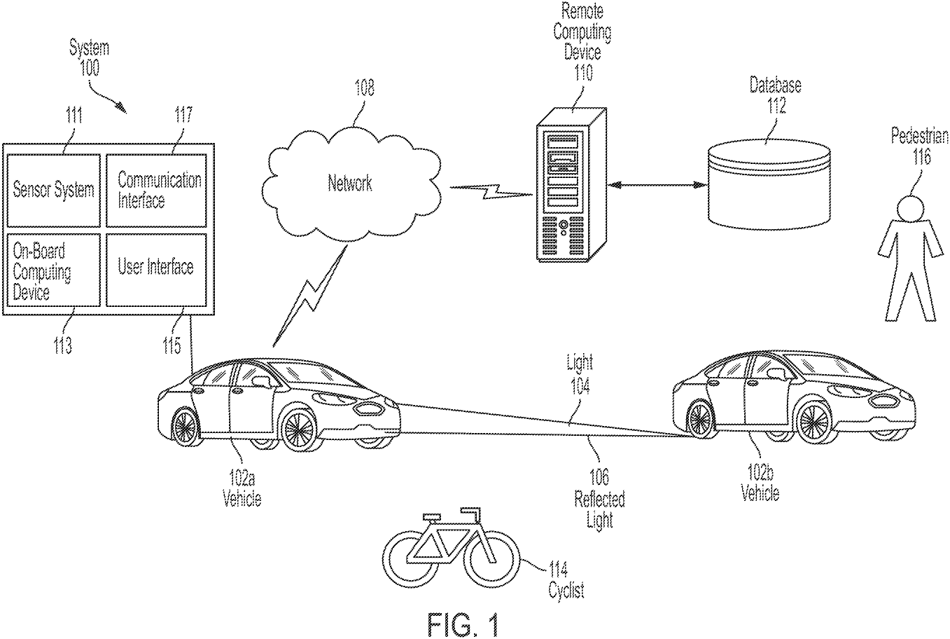

FIG. 1 illustrates an exemplary autonomous vehicle system 100, in accordance with aspects of the disclosure. The system 100 comprises a vehicle 102a that is traveling along a road in a semi-autonomous or autonomous manner. Vehicle 102a is also referred to herein as AV 102a. AV 102a can include, but is not limited to, a land vehicle (as shown in FIG. 1), an aircraft, or a watercraft.

The AV 102a is generally configured to detect objects 102b, 114, 116 in proximity thereto. The objects can include, but are not limited to, a vehicle 102b, cyclist 114 (such as a rider of a bicycle, electric scooter, motorcycle, or the like) and/or a pedestrian 116.

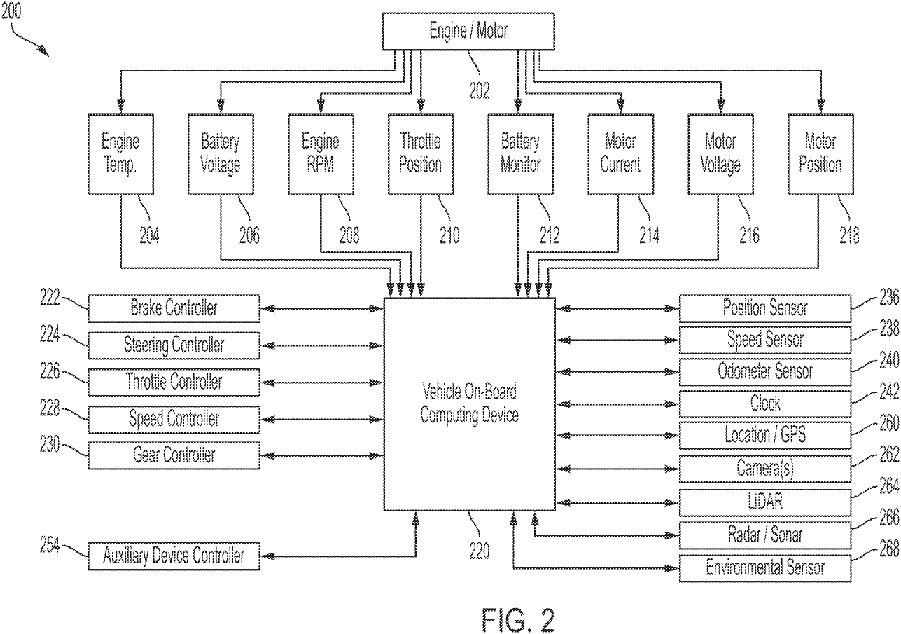

As illustrated in FIG. 1, the AV 102a may include a sensor system 111, an on-board computing device 113, a communications interface 117, and a user interface 115. Autonomous vehicle 101 may further include certain components (as illustrated, for example, in FIG. 2) included in vehicles, which may be controlled by the on-board computing device 113 using a variety of communication signals and/or commands, such as, for example, acceleration signals or commands, deceleration signals or commands, steering signals or commands, braking signals or commands, etc.

The sensor system 111 may include one or more sensors that are coupled to and/or are included within the AV 102a, as illustrated in FIG. 2. For example, such sensors may include, without limitation, a LiDAR system, a radio detection and ranging (RADAR) system, a laser detection and ranging (LADAR) system, a sound navigation and ranging (SONAR) system, one or more cameras (e.g., visible spectrum cameras, infrared cameras, etc.), temperature sensors, position sensors (e.g., global positioning system (GPS), etc.), location sensors, fuel sensors, motion sensors (e.g., inertial measurement units (IMU), etc.), humidity sensors, occupancy sensors, or the like. The sensor data can include information that describes the location of objects within the surrounding environment of the AV 102a, information about the environment itself, information about the motion of the AV 102a, information about a route of the vehicle, or the like. As AV 102a travels over a surface, at least some of the sensors may collect data pertaining to the surface.

As will be described in greater detail, the AV 102a may be configured with a lidar system, e.g., lidar system 264 of FIG. 2. The lidar system may be configured to transmit a light pulse 104 to detect objects located within a distance or range of distances of the AV 102a. Light pulse 104 may be incident on one or more objects (e.g., AV 102b) and be reflected back to the lidar system. Reflected light pulse 106 incident on the lidar system may be processed to determine a distance of that object to AV 102a. The reflected light pulse 106 may be detected using, in some embodiments, a photodetector or array of photodetectors positioned and configured to receive the light reflected back into the lidar system. Lidar information, such as detected object data, is communicated from the lidar system to an on-board computing device, e.g., on-board computing device 220 of FIG. 2. The AV 102a may also communicate lidar data to a remote computing device 110 (e.g., cloud processing system) over communications network 108. Remote computing device 110 may be configured with one or more servers to process one or more processes of the technology described herein. Remote computing device 110 may also be configured to communicate data/instructions to/from AV 102a over network 108, to/from server(s) and/or database(s) 112.

It should be noted that the LiDAR systems for collecting data pertaining to the surface may be included in systems other than the AV 102a such as, without limitation, other vehicles (autonomous or driven), robots, satellites, etc.

Network 108 may include one or more wired or wireless networks. For example, the network 108 may include a cellular network (e.g., a long-term evolution (LTE) network, a code division multiple access (CDMA) network, a 3G network, a 4G network, a 5G network, another type of next generation network, etc.). The network 108 may also include a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, a cloud computing network, and/or the like, and/or a combination of these or other types of networks.

The AV 102a may retrieve, receive, display, and edit information generated from a local application or delivered via network 108 from database 112. Database 112 may be configured to store and supply raw data, indexed data, structured data, map data, program instructions or other configurations as is known.

The communications interface 117 may be configured to allow communication between AV 102a and external systems, such as, for example, external devices, sensors, other vehicles, servers, data stores, databases etc. The communications interface 117 may utilize any now or hereafter known protocols, protection schemes, encodings, formats, packaging, etc. such as, without limitation, Wi-Fi, an infrared link, Bluetooth, etc. The user interface system 115 may be part of peripheral devices implemented within the AV 102a including, for example, a keyboard, a touch screen display device, a microphone, and a speaker, etc.

FIG. 2 illustrates an exemplary system architecture 200 for a vehicle, in accordance with aspects of the disclosure. The vehicles 102a and/or 102b of FIG. 1 may have the same or similar system architecture as that shown in FIG. 2. Thus, the following discussion of system architecture 200 is sufficient for understanding vehicle(s) 102a, 102b of FIG. 1. However, other types of vehicles are considered within the scope of the technology described herein and may contain more or less elements as described in association with FIG. 2. As a non-limiting example, an airborne vehicle may exclude brake or gear controllers, but may include an altitude sensor. In another non-limiting example, a water-based vehicle may include a depth sensor. One skilled in the art will appreciate that other propulsion systems, sensors and controllers may be included based on a type of vehicle, as is known.

As shown in FIG. 2, system architecture 200 includes an engine or motor 202 and various sensors 204-218 for measuring various parameters of the vehicle. In gas-powered or hybrid vehicles having a fuel-powered engine, the sensors may include, for example, an engine temperature sensor 204, a battery voltage sensor 206, an engine Rotations Per Minute (“RPM”) sensor 208, and a throttle position sensor 210. If the vehicle is an electric or hybrid vehicle, then the vehicle may have an electric motor, and accordingly includes sensors such as a battery monitoring system 212 (to measure current, voltage and/or temperature of the battery), motor current 214 and voltage 216 sensors, and motor position sensors 218 such as resolvers and encoders.

Operational parameter sensors that are common to both types of vehicles include, for example: a position sensor 236 such as an accelerometer, gyroscope and/or inertial measurement unit; a speed sensor 238; and an odometer sensor 240. The vehicle also may have a clock 242 that the system uses to determine vehicle time during operation. The clock 242 may be encoded into the vehicle on-board computing device, it may be a separate device, or multiple clocks may be available.

The vehicle also includes various sensors that operate to gather information about the environment in which the vehicle is traveling. These sensors may include, for example: a location sensor 260 (e.g., a Global Positioning System (“GPS”) device); object detection sensors such as one or more cameras 262; a lidar system 264; and/or a radar and/or a sonar system 266. The sensors also may include environmental sensors 268 such as a precipitation sensor and/or ambient temperature sensor. The object detection sensors may enable the vehicle to detect objects that are within a given distance range of the vehicle 200 in any direction, while the environmental sensors collect data about environmental conditions within the vehicle’s area of travel.

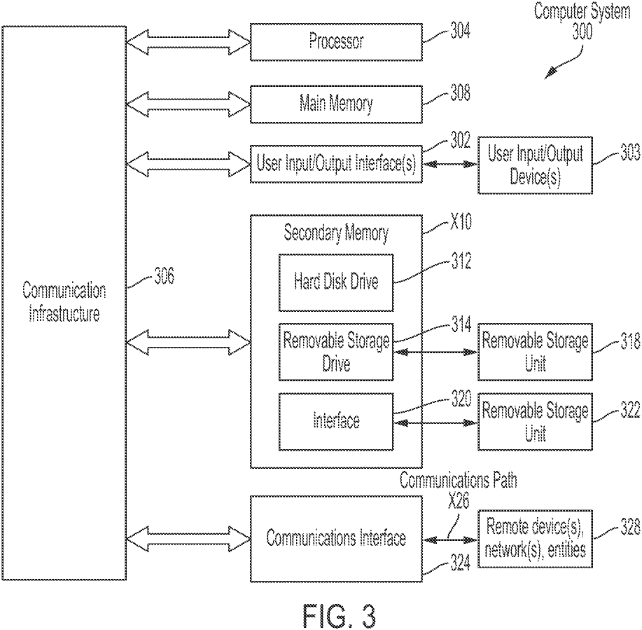

During operations, information is communicated from the sensors to a vehicle on-board computing device 220. The on-board computing device 220 may implemented using the computer system 300 of FIG. 3. The vehicle on-board computing device 220 analyzes the data captured by the sensors and optionally controls operations of the vehicle based on results of the analysis. For example, the vehicle on-board computing device 220 may control: braking via a brake controller 222; direction via a steering controller 224; speed and acceleration via a throttle controller 226 (in a gas-powered vehicle) or a motor speed controller 228 (such as a current level controller in an electric vehicle); a differential gear controller 230 (in vehicles with transmissions); and/or other controllers. Auxiliary device controller 254 may be configured to control one or more auxiliary devices, such as testing systems, auxiliary sensors, mobile devices transported by the vehicle, etc.

Geographic location information may be communicated from the location sensor 260 to the on-board computing device 220, which may then access a map of the environment that corresponds to the location information to determine known fixed features of the environment such as streets, buildings, stop signs and/or stop/go signals. Captured images from the cameras 262 and/or object detection information captured from sensors such as lidar system 264 is communicated from those sensors) to the on-board computing device 220. The object detection information and/or captured images are processed by the on-board computing device 220 to detect objects in proximity to the vehicle 200. Any known or to be known technique for making an object detection based on sensor data and/or captured images can be used in the embodiments disclosed in this document.

Lidar information is communicated from lidar system 264 to the on-board computing device 220. Additionally, captured images are communicated from the camera(s) 262 to the vehicle on-board computing device 220. The lidar information and/or captured images are processed by the vehicle on-board computing device 220 to detect objects in proximity to the vehicle 200. The manner in which the object detections are made by the vehicle on-board computing device 220 includes such capabilities detailed in this disclosure.

The on-board computing device 220 may include and/or may be in communication with a routing controller 231 that generates a navigation route from a start position to a destination position for an autonomous vehicle. The routing controller 231 may access a map data store to identify possible routes and road segments that a vehicle can travel on to get from the start position to the destination position.

In various embodiments, the on-board computing device 220 may determine perception information of the surrounding environment of the AV 102a. Based on the sensor data provided by one or more sensors and location information that is obtained, the on-board computing device 220 may determine perception information of the surrounding environment of the AV 102a. The perception information may represent what an ordinary driver would perceive in the surrounding environment of a vehicle. The perception data may include information relating to one or more objects in the environment of the AV 102a. For example, the on-board computing device 220 may process sensor data (e.g., LiDAR or RADAR data, camera images, etc.) in order to identify objects and/or features in the environment of AV 102a. The objects may include traffic signals, road way boundaries, other vehicles, pedestrians, and/or obstacles, etc. The on-board computing device 220 may use any now or hereafter known object recognition algorithms, video tracking algorithms, and computer vision algorithms (e.g., track objects frame-to-frame iteratively over a number of time periods) to determine the perception.

In some embodiments, the on-board computing device 220 may also determine, for one or more identified objects in the environment, the current state of the object. The state information may include, without limitation, for each object: current location; current speed and/or acceleration, current heading; current pose; current shape, size, or footprint; type (e.g., vehicle vs. pedestrian vs. bicycle vs. static object or obstacle); and/or other state information.

The on-board computing device 220 may perform one or more prediction and/or forecasting operations. For example, the on-board computing device 220 may predict future locations, trajectories, and/or actions of one or more objects. For example, the on-board computing device 220 may predict the future locations, trajectories, and/or actions of the objects based at least in part on perception information (e.g., the state data for each object comprising an estimated shape and pose determined as discussed below), location information, sensor data, and/or any other data that describes the past and/or current state of the objects, the AV 102a, the surrounding environment, and/or their relationship(s). For example, if an object is a vehicle and the current driving environment includes an intersection, the on-board computing device 220 may predict whether the object will likely move straight forward or make a turn. If the perception data indicates that the intersection has no traffic light, the on-board computing device 220 may also predict whether the vehicle may have to fully stop prior to enter the intersection.

In various embodiments, the on-board computing device 220 may determine a motion plan for the autonomous vehicle. For example, the on-board computing device 220 may determine a motion plan for the autonomous vehicle based on the perception data and/or the prediction data. Specifically, given predictions about the future locations of proximate objects and other perception data, the on-board computing device 220 can determine a motion plan for the AV 102a that best navigates the autonomous vehicle relative to the objects at their future locations.

In some embodiments, the on-board computing device 220 may receive predictions and make a decision regarding how to handle objects and/or actors in the environment of the AV 102a. For example, for a particular actor (e.g., a vehicle with a given speed, direction, turning angle, etc.), the on-board computing device 220 decides whether to overtake, yield, stop, and/or pass based on, for example, traffic conditions, map data, state of the autonomous vehicle, etc. Furthermore, the on-board computing device 220 also plans a path for the AV 102a to travel on a given route, as well as driving parameters (e.g., distance, speed, and/or turning angle). That is, for a given object, the on-board computing device 220 decides what to do with the object and determines how to do it. For example, for a given object, the on-board computing device 220 may decide to pass the object and may determine whether to pass on the left side or right side of the object (including motion parameters such as speed). The on-board computing device 220 may also assess the risk of a collision between a detected object and the AV 102a. If the risk exceeds an acceptable threshold, it may determine whether the collision can be avoided if the autonomous vehicle follows a defined vehicle trajectory and/or implements one or more dynamically generated emergency maneuvers is performed in a pre-defined time period (e.g., N milliseconds). If the collision can be avoided, then the on-board computing device 220 may execute one or more control instructions to perform a cautious maneuver (e.g., mildly slow down, accelerate, change lane, or swerve). In contrast, if the collision cannot be avoided, then the on-board computing device 220 may execute one or more control instructions for execution of an emergency maneuver (e.g., brake and/or change direction of travel).

As discussed above, planning and control data regarding the movement of the autonomous vehicle is generated for execution. The on-board computing device 220 may, for example, control braking via a brake controller; direction via a steering controller; speed and acceleration via a throttle controller (in a gas-powered vehicle) or a motor speed controller (such as a current level controller in an electric vehicle); a differential gear controller (in vehicles with transmissions); and/or other controllers.

Various embodiments can be implemented, for example, using one or more computer systems, such as computer system 300 shown in FIG. 3. Computer system 300 can be any computer capable of performing the functions described herein.

Computer system 300 can be any well-known computer capable of performing the functions described herein.

Computer system 300 includes one or more processors (also called central processing units, or CPUs), such as a processor 304. Processor 304 is connected to a communication infrastructure or bus 306.

One or more processors 304 may each be a graphics processing unit (GPU). In an embodiment, a GPU is a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 300 also includes user input/output device(s) 303, such as monitors, keyboards, pointing devices, etc., that communicate with communication infrastructure 306 through user input/output interface(s) 302.

Computer system 300 also includes a main or primary memory 308, such as random access memory (RAM). Main memory 308 may include one or more levels of cache. Main memory 308 has stored therein control logic (i.e., computer software) and/or data.

Computer system 300 may also include one or more secondary storage devices or memory 310. Secondary memory 310 may include, for example, a hard disk drive 312 and/or a removable storage device or drive 314. Removable storage drive 314 may be a floppy disk drive, a magnetic tape drive, a compact disk drive, an optical storage device, tape backup device, and/or any other storage device/drive.

Removable storage drive 314 may interact with a removable storage unit 318. Removable storage unit 318 includes a computer usable or readable storage device having stored thereon computer software (control logic) and/or data. Removable storage unit 318 may be a floppy disk, magnetic tape, compact disk, DVD, optical storage disk, and/ any other computer data storage device. Removable storage drive 314 reads from and/or writes to removable storage unit 318 in a well-known manner.

According to an exemplary embodiment, secondary memory 310 may include other means, instrumentalities or other approaches for allowing computer programs and/or other instructions and/or data to be accessed by computer system 300. Such means, instrumentalities or other approaches may include, for example, a removable storage unit 322 and an interface 320. Examples of the removable storage unit 322 and the interface 320 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 300 may further include a communication or network interface 324. Communication interface 324 enables computer system 300 to communicate and interact with any combination of remote devices, remote networks, remote entities, etc. (individually and collectively referenced by reference number 328). For example, communication interface 324 may allow computer system 300 to communicate with remote devices 328 over communications path 326, which may be wired and/or wireless, and which may include any combination of LANs, WANs, the Internet, etc. Control logic and/or data may be transmitted to and from computer system 300 via communication path 326.

In an embodiment, a tangible, non-transitory apparatus or article of manufacture comprising a tangible, non-transitory computer useable or readable medium having control logic (software) stored thereon is also referred to herein as a computer program product or program storage device. This includes, but is not limited to, computer system 300, main memory 308, secondary memory 310, and removable storage units 318 and 322, as well as tangible articles of manufacture embodying any combination of the foregoing. Such control logic, when executed by one or more data processing devices (such as computer system 300), causes such data processing devices to operate as described herein.

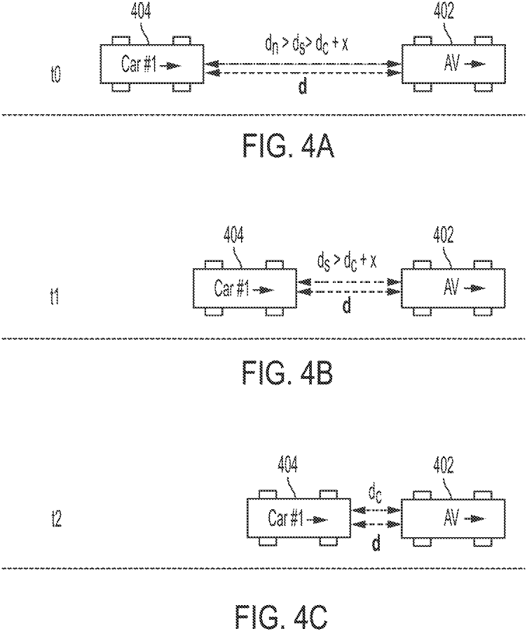

FIG. 4A illustrates an example schematic of an autonomous vehicle (AV) 402 and a trailing vehicle 404 having a first distance between each other. The AV 402 and trailing vehicle 404 may be similar to vehicle 102 as described above with respect to FIG. 1. In one example, the AV 402 may have autonomous characteristics and may be capable of certain functions available to AVs, while the trailing vehicle 404 may be a non-autonomous vehicle that may be slightly limited in features and functionality. For example, the trailing vehicle 404 may not be capable of vehicle to vehicle communication, while the AV 402 is capable of such functions.

In the example in FIG. 4A, the AV 402 may be driving along a roadway and the trailing vehicle 404 may be driving in the same direction but behind the AV 402. As explained above, the AV 402 may include the sensor system 111. The sensor system 111 may include one or more sensors that are coupled to and/or are included within the AV 402, as illustrated in FIG. 2. The sensor data can include information that describes the location of objects within the surrounding environment of the AV 402, such as the trailing vehicle 404.

The sensor data may provide information about the trailing vehicle 404 such as its location relative to the AV 402. From the location, as well as current speed of the AV 402, the AV 402 may also determine a speed of the trailing vehicle 404. From the sensor data, the AV 402 may also determine a distance d between the AV 402 and the trailing vehicle 404. The distance d may be continually calculated and monitored based on the continually updated sensor data.

Additionally or alternatively, in the event that the trailing vehicle 404 is also an AV and has vehicle to vehicle communication capabilities, the trailing vehicle 404 may transmit its position, speed, or other data, directly to the AV 402. Further, the trailing vehicle 404 may be capable of determining the distance d between the vehicles itself based on its own sensor system 111.

Once the AV 402 determines the distance d, the AV 402 may proceed to determine whether distance d exceeds any specific or predefined threshold distances. These threshold distances may be distances related to acceptable following distances of the trailing vehicle 402 and may be considered sensitive, critical, normal, etc. For example, a normal threshold distance between the vehicles may mean that even if the AV 402 would brake abruptly, the trailing vehicle 404 may have time to apply its brakes and decelerate without a high likelihood that the trailing vehicle 404 may come into contact with the AV 402. In another example, a critical threshold may indicate that the trailing vehicle 404 would be unable to brake or stop in time to avoid collision with the AV 402. In yet another example, a sensitive threshold may indicate that while it would be possible for the trailing vehicle 404 to stop in time, a greater distance between the vehicles would likely be preferred.

Referring specifically to FIGS. 4A-C, the figures illustrate the relative position between the AV 402 and the trailing vehicle 404 at three different times: t0, t1, t2. The AV system continually estimates the trailing vehicle’s position, velocity, and direction in relation to the AV to determine the distance (d) between the vehicles, where d is derived using a speed dependent calculation. The AV system compares distance d to various threshold distances. In the examples herein, the threshold distances may include a critical distance d_{c}, a sensitive distance dₛ, and a normal distance dₙ, and a threshold distance X.

FIG. 4A illustrates an example of the two vehicles having a first distance therebetween each other. In this example, the trailing vehicle 404 is determined to be traveling behind the AV 402 at an acceptable distance. This may be determined based on the first distance exceeding a normal distance dₙ. The normal distance dₙ may be greater than the sensitive distance dₛ, which is greater than the sum of the critical distance d_{c} and the threshold distance X. In some embodiments, the threshold distance X may vary based on a number of different factors, such as the speeds of the vehicles, road conditions (e.g., dry road conditions, wet road conditions, snowy road conditions, icy road conditions, etc.), road types (e.g., paved road, dirt roads, gravel roads, etc.). For example, the threshold distance X increases as the speed of the vehicles increase. As on example, in dry road conditions, at 20 miles per hour (MPH), the threshold distance X may be 40 feet (ft), whereas at 30 MPH, the threshold distance X may be 75 ft. Similarly, different road conditions may dictate that the threshold distance X increase as well, e.g., the threshold distance X may increase in wet, snowy, or icy conditions as compared to the threshold distance X in dry conditions. Likewise, different road types may dictate that the threshold distance X increase as well, e.g., the threshold distance Xmay increase on dirt and/or gravel roads as compared to the normal threshold distance dₙ on paved roads. Thus, the AV 402 may continuously compute the threshold distance X based on the number of different factors. The remaining distances, such as d_{c}, dₛ, and dₙ may all vary similar to the threshold distance X, or be based on the threshold distance X.

FIG. 4B illustrates an example schematic of an autonomous vehicle and a trailing vehicle having a second distance therebetween. In this example, the trailing vehicle 404 is determined to be traveling behind the AV 402 at a sensitive distance. This may be determined based on the second distance failing to exceed a sensitive threshold distance dₛ that is less than the normal threshold distance dₙ. This may explain that while it would be possible for the trailing vehicle 404 to stop in time, a greater distance between the vehicles would likely be preferred. The sensitive threshold distance dₛ, like the normal threshold distance dₙ, may vary based on the number of different factors. As on example, in dry road conditions, at 20 miles per hour (MPH), the sensitive threshold distance dₛ may be between 20 ft and 40 ft, whereas at 30 MPH, the sensitive threshold distance dₛ may be between 46 ft and 75 ft.

FIG. 4C illustrates an example schematic of an autonomous vehicle and a trailing vehicle having a third distance therebetween. In this example, the trailing vehicle 404 is determined to be traveling behind the AV 402 at a critical distance. This may be determined based on the third distance failing to exceed a critical threshold distance d_{c}. The critical threshold distance d_{c}, like the normal threshold distance dₙ, may vary based on the number of different factors. As on example, in dry road conditions, at 20 miles per hour (MPH), the critical threshold distance d_{c} may be less than 20 ft or less, whereas at 30 MPH, the critical threshold distance d_{c} may be 46 ft or less. In this example the trailing vehicle 404 would be unable to brake or stop in time to avoid collision with the AV 402. It should be understood that these are merely example distances, and that other distances are further contemplated in accordance with aspects of the present disclosure.

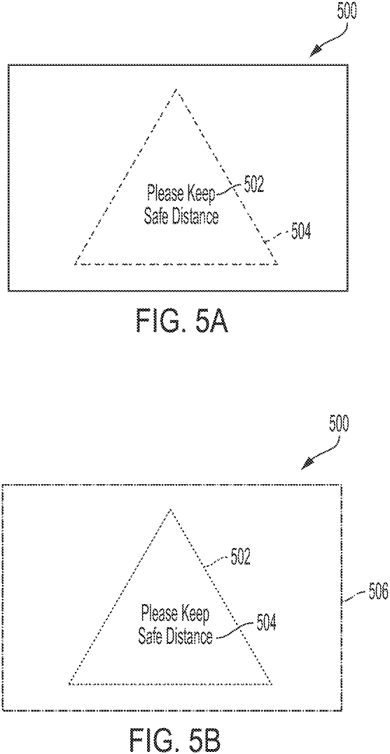

In situations where the distance d does not exceed one or more thresholds, such as those illustrated by way of example in FIGS. 4B and 4C, the AV 402 may issue one or more alerts. These alerts may be issued in a number of ways. In one example, the alert may be a visual alert presented by and on the AV 402 to be visible to the driver of the trailing vehicle 404 and/or an occupant of the AV 402. As one example, the visual alert may be presented via a back window display of the AV 402, such that the visual alert may be visible to the driver of the trailing vehicle 404. The back window display may be a screen display device similar to the user interface 115, and may include LED, LCD, etc., displays. This is described in more detail below with respect to FIGS. 5A and 5B. As another example, the visual alert may be presented via a display inside the AV 402 to the occupant.

When reviewing FIGS. 4A-4C in sequence, the distance d between the vehicles decreases from t₀ to t₂. In the examples disclosed herein, dₙ is greater than dₛ, and dₛ is greater than d_{c}, such that dₙ > dₛ > d_{c}. As the distance d between the vehicles decreases, so does the level of alert. As shown in FIG. 4A, at t₀, the AV system determines that distance d is greater than d_{c} + X, and does not provide a message to an operator of the vehicle 404 or the occupant of the AV 402. That is, the distance d may exceed the normal distance threshold dₙ.

As shown in FIG. 4B, at t₁, the AV system determines that distance d is equal to d_{c} + X, and then provides an alert message to the operator of the trailing vehicle 404 by illuminating an image on a rear window of the AV or the occupant of the AV 402 by illuminating a display within the AV 402. In this example, the distance d fails to exceed a sensitive threshold distance dₛ that is less than the normal threshold distance dₙ.

As shown in FIG. 4C, at t2, the AV system determines that distance d is equal to d_{c}, and then provides a modified alert message to the operator of the vehicle 404 or the occupant of the AV 402, possibly by blinking the image. Such an alert may have a dynamic component, contrary to the static message of FIG. 4B, to heighten the awareness level of the alert. The critical threshold distance d_{c} may be less than the sensitive threshold distance dₛ.

Thus, the AV system updates the alert as necessary depending on the changing distance d. The above thresholds are merely intended to be exemplary and more or less thresholds, levels, and tiers may be contemplated.

FIG. 5A illustrates an example display 500 presenting a visual alert 502 to a trailing vehicle 404. In this example, the visual alert 502 illustrates a caution triangle with a message 504. The alert 502 may be considered a static alert. The message 504 and alert in general, may provide the trailing vehicle 404 with information about the vehicle’s driving and providing further instruction such as to keep a safe distance, etc. This may be advantageous in the examples where the trailing vehicle 404 is not an AV. This may be the case where the alert is considered a sensitive alert in response to the distance d failing to exceed the sensitive threshold distance.

FIG. 5B illustrates the example display 500 presenting the visual alert 502 and a special effect 506, or dynamic alert. In this example, the visual alert 502 illustrates the caution triangle with a message 504, similar to FIG. 5A. However, an additional special affect 506 such as a blinking or flashing of the alert may also be presented. This may be to draw additional attendant to the alert. This may be the case where the alert is considered a critical alert in response to the distance d failing to exceed the critical threshold distance.

The message 504 and alert in general, may provide the trailing vehicle 404 with information about the vehicle’s driving and providing further instruction such as to keep a safe distance, etc. This may be advantageous in the examples where the trailing vehicle 404 is not an AV.

The AV 402 may provide tailored alerts based on the distance d between the AV 402 and the trailing vehicle 404. For example, various “levels” or “tiers” of alerts may be presented based on the distance d. The form or content of the alert may coincide with a certain one of the threshold distances, as described above. For instance, if the distance d between the vehicles is classified as a critical distance, in that the distance does not exceed the thresholds and is less than the critical threshold distance, a critical alert may be presented. On the other hand, if the distance d fails to exceed the critical threshold distance, but does exceed the sensitive threshold distance, the distance is thus classified as a sensitive distance and a sensitive alert may be presented. The sensitive alert may include a less severe message 504, such as “Please keep safe distance,” while the critical alert may be more abrasive, such as “WARNING,” in some examples.

In addition to the message 504, the visual presentation of the alert may vary across the alert levels. In some examples, the color and/or effect of the alert may change. A critical alert may have a red colored triangle or message, while a sensitive alert may be yellow. If no alert is to be generated or presented, a default message 504 may be displayed, or simply a green triangle, or other shape.

In addition to the above, the alert may change forms gradually. For example, an intermittent blinking of the alert in the sensitive level may gradually increase in frequency as the distance d between the vehicles decreases. Further, the size of the shape of the message may gradually increase as the distance decreases. Audible sounds may similarly increase in amplitude. This may signal to the trailing vehicle 404 the lack of safe following distance between the vehicles.

The alert, as mentioned may be issued audibly through a speaker on the AV 402. This may include spoken alerts, sounds that may indicate a warning such as a beeping, etc. The volume or the frequency of the sounds may increase or decrease depending on the alert level. Further, the sounds may accompany the visual alert provided by the display 500.

In the case where the trailing vehicle 404 is capable of vehicle to vehicle communication, or, additionally or alternatively, a user device within the trailing vehicle 404 is capable of receiving alerts via a vehicle to device communication, the alerts descried above may be presented by a user interface 115 within the trailing vehicle 404 and/or the mobile device. The message 504 as illustrated in FIGS. 5 may be presented via the user interface 115, and audible sounds may be provided by the trailing vehicle 404. Haptic feedback may also be provided via the vehicle seats, steering wheel, etc.

Further, in the case where the trailing vehicle 404 is an AV, the AV 402 may transmit a message to the trailing vehicle 404 to instruct the trailing vehicle 404 to stop, slow down, or take other remedial actions to increase the distance d between the vehicles.

Whether the alert is presented by the AV 402 or the trailing vehicle 404, the alert may also be customized based on vehicle location, and specifically, to meet local requirements, laws, regulations, for the jurisdiction in which the AV 402 is currently located. For example, one jurisdiction may allow for messages to be displayed on the display 500, while others may only allow for flashing or blinking lights. Regardless, the system is intended to improve satisfaction and decrease collisions between vehicles due to close trailing distances.

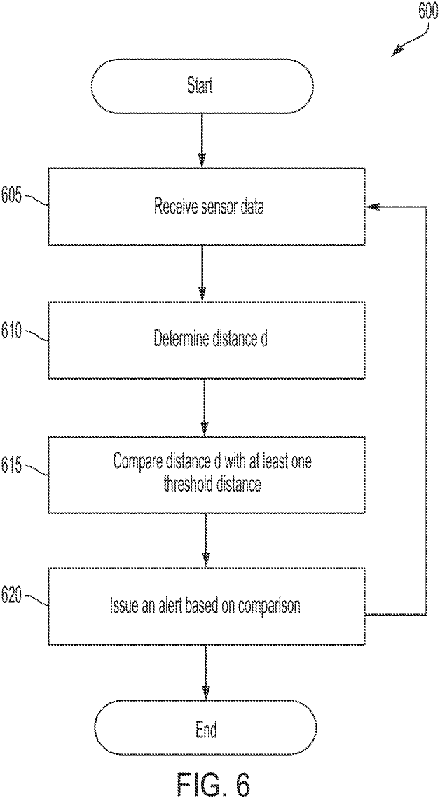

FIG. 6 is a flow chart illustrating a method for the vehicle system of FIG. 1. The process 600 begins at block 605 where the AV 402 may receive the sensor data. As explained, the sensor data may include information that describes the location of objects within the surrounding environment of the AV 402, such as the trailing vehicle 404. The sensor data may also include data from the trailing vehicle 404 itself, should the trailing vehicle 404 have vehicle to vehicle or over the air capabilities.

At block 610, the AV 402 may determine the distance d between the vehicles. This may be determined based on the predicted behavior of the trailing vehicle 404 based on the sensor data provided by the sensor system 111.

At block 615, the AV 402 may compare the distance with at least one predefined threshold distance. The predefined threshold distance may be a threshold distance that may be considered an appropriate following distance of the trailing vehicle 404. More than one threshold may be considered, for example, the critical threshold distance and the sensitive threshold as described above with respect to FIGS. 4A-4C.

At block 620, the AV 402 may issue an alert based on the comparison of the distance d to the one or more threshold distances. For example, if the distance d fails to exceed the critical threshold, a critical alert may be issued, as described above with respect to FIG. 5B, for example. In another example, if the distance d does exceed the critical threshold but fails to exceed a lesser, sensitive threshold, the AV 402 may issue a sensitive alert, as described above with respect to FIG. 5A, for example. Should the distance d exceed the one or more predefined thresholds, a normal alert, may be presented, or no alert may be issued.

The AV 402 may continually update the distance d, and may update the alert as needed. That is, the alert may increase in severity as the distance d decreases, or move from the sensitive alert to the critical alert.

The process 600 may continue until the trailing vehicle 404 no longer is following the AV 402, or until another trigger event occurs, such as the trailing vehicle 404 has not been within a predefined distance of the AV 402 for a predefined amount of time, etc.

Accordingly, described herein is an autonomous vehicle (AV) system and method for leading AV to trailing vehicle distance estimation. The AV system uses existing sensing and computing capabilities to detect, track, and predict the behavior of a vehicle behind the autonomous vehicle, i.e., a trailing vehicle. The AV system estimates the trailing vehicle’s position, velocity, and heading relative to the AV, and then provides a message to a driver of the trailing vehicle that represents this information. The message may include an illuminated image combined with text (e.g., an LED sign) that is displayed on a rear window of the AV. The alert may include an image (red triangle) and/or text, i.e., “Please keep safety distance.” At a second, closer distance, the AV system determines that distance d has decreased and may then provide a modified warning message to the operator of the rear vehicle by blinking the image on the rear window of the AV. The AV system may also provide the message to the trailing vehicle wirelessly, e.g., by vehicle-to-vehicle communication, if the trailing vehicle includes a smart system to receive such information.

Based on the teachings contained in this disclosure, it will be apparent to persons skilled in the relevant art(s) how to make and use embodiments of this disclosure using data processing devices, computer systems and/or computer architectures other than that shown in FIG. 3. In particular, embodiments can operate with software, hardware, and/or operating system implementations other than those described herein.

Based on the teachings contained in this disclosure, it will be apparent to persons skilled in the relevant art(s) how to make and use embodiments of this disclosure using data processing devices, computer systems and/or computer architectures other than that shown in FIG. 3. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other. The breadth and scope of this disclosure should not be limited by any of the above-described exemplary embodiments, but should be defined only in accordance with the following claims and their equivalents.

While exemplary embodiments are described above, it is not intended that these embodiments describe all possible forms of the disclosure. Rather, the words used in the specification are words of description rather than limitation, and it is understood that various changes may be made without departing from the spirit and scope of the disclosure. Additionally, the features of various implementing embodiments may be combined to form further embodiments.

What is claimed is:

1. An autonomous vehicle having a lead vehicle training system, comprising:
a memory; and
at least one processor coupled to the memory and programmed to:
receive sensor data indicative of a location of a vehicle trailing the autonomous vehicle;
compare a distance between the vehicle trailing the autonomous vehicle and the autonomous vehicle with at least one predefined threshold distance; and
issue an alert responsive to the comparison to provide instructions to the vehicle trailing the autonomous vehicle.

2. The vehicle of claim 1, wherein the at least one predefined threshold distance includes a plurality of threshold distances, each associated with an alert.

3. The vehicle of claim 2, wherein the processor is further programmed to issue the alert associated with the at least one threshold distance in response to the distance failing to exceed the respective one of the at least on threshold distance.

4. The vehicle of claim 3, wherein the processor is further programmed to issue instructions to a display at the autonomous vehicle and visible by the vehicle trailing the autonomous vehicle to present the alert.

5. The vehicle of claim 3, wherein the plurality of thresholds include a sensitive threshold associated with a sensitive alert.

6. The vehicle of claim 5, wherein the sensitive alert includes a static visual alert.

7. The vehicle of claim 5, wherein the plurality of thresholds include a critical threshold distance associated with a critical alert, the critical threshold distance being less than that sensitive threshold distance.

8. The vehicle of claim 7, wherein the critical alert includes a dynamic visual alert.

9. A method comprising:
receiving sensor data indicative of a location of a vehicle trailing an autonomous vehicle;
comparing a distance between the vehicle trailing the autonomous vehicle and the autonomous vehicle with at least one predefined threshold distance; and
issuing an alert responsive to the comparison to provide instructions to the vehicle trailing the autonomous vehicle.

10. The method of claim 9, wherein the at least one predefined threshold distance includes a plurality of threshold distances, each associated with an alert.

11. The method of claim 10, wherein the alert is associated with the at least one threshold distance in response to the distance failing to exceed the respective ones of the at least on threshold distance.

12. The method of claim 11, further comprising issuing instructions to a display at the autonomous vehicle and visible by the vehicle trailing the autonomous vehicle to present the alert.

13. The method of claim 11, wherein the plurality of thresholds include a sensitive threshold associated with a sensitive alert.

14. The method of claim 13, wherein the sensitive alert includes a static visual alert.

15. The method of claim 13, wherein the plurality of thresholds include a critical threshold distance associated with a critical alert, the critical threshold distance being less than that sensitive threshold distance.

16. The method of claim 15, wherein the critical alert includes a dynamic visual alert.

17. A non-transitory computer-readable medium having instructions stored thereon that, when executed by at least one computing device, cause the at least one computing device to perform operations comprising:
receiving sensor data indicative of a location of a vehicle trailing an autonomous vehicle;
comparing a distance between the vehicle trailing the autonomous vehicle and the autonomous vehicle with at least one predefined threshold distance; and
issuing an alert responsive to the comparison to provide instructions to the vehicle trailing the autonomous vehicle.

18. The medium of claim 17, wherein the at least one predefined threshold distance includes a plurality of threshold distances, each associated with an alert.

19. The medium of claim 18, wherein the alert is associated with the at least one threshold distance in response to the distance failing to exceed the respective ones of the at least on threshold distance.

20. The medium of claim 18, further comprising issuing instructions to a display at the autonomous vehicle and visible by the vehicle trailing the autonomous vehicle to present the alert.
